(19) United States
(12) Patent Application Publication
(10) Pub. No.: US 2005/0185718 A1
(43) Pub. Date: Aug. 25, 2005

(54) Pipeline quality control

(75) Inventor: Patrick N. Nelson, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/775,490

(22) Filed: Feb. 9, 2004

(51) Int. Cl. H04N 7/12

(52) U.S. Cl. 375/240.27; 375/240.28

(57) ABSTRACT

Systems and methods determine whether samples of a multimedia presentation are being processed in a multi-component pipeline in a timely manner. If samples are not being processed in a timely manner, various actions are taken to correct the timeliness issues.

### BACKGROUND

Multimedia presentation may include audio and video data, as well as other data, such as meta-data, markers, events, and IP data, which are associated with the audio and video data. Multimedia presentations typically include various streams of data, each composed of a number of data samples.

Multimedia presentations are often accessed using a multimedia playback architecture running on a personal computer. The multimedia playback architecture may include a number of components, each of which provides some sort of processing or handling of the data samples of the multimedia presentation.

Often times, in addition to running the multimedia playback architecture, the personal computer may be asked to run various other programs or processes. Unfortunately, in situations where the personal computer is underpowered for the tasks demanded of it, the timing of the presentation may suffer. For example, samples of the presentation may not be processed at their expected time. This may cause any number of problems in the proper processing and presentation of the multimedia presentation.

### SUMMARY

Described herein are various systems and methods that provide quality control for the processing of multimedia presentations. More particularly, various systems and methods described herein monitor the timing of the data samples of a multimedia presentation as the samples are processed in a multi-component pipeline. If the timing of one or more samples does not agree with prescribed timing of the media presentation, one or more of the components in the pipeline may be instructed to take some form of corrective action.

### BRIEF DESCRIPTION OF THE DRAWINGS

FIG. 1 is an illustration of one environment in which a computer provides access to a plurality of media in accordance with various systems and methods described herein.

FIG. 2 is a high level block diagram of a multimedia presentation system including, among other things, systems and methods of quality manager described herein.

FIG. 3 illustrates further details of the multimedia presentation system shown in FIG. 2.

FIG. 4 illustrates an operational flow including various quality control operations.

FIG. 5 illustrates another operational flow including various quality control operations.

FIG. 6 illustrates one possible environment in which the systems and methods described herein may be employed.

### DETAILED DESCRIPTION

Described herein are implementations of various systems and methods for providing quality control in a multimedia system. In general, the various systems and methods described herein monitor the timing of the data samples of a multimedia presentation as the samples are processed in a multi-component pipeline. If the timing of one or more samples does not agree with prescribed timing of the media presentation, one or more of the components in the pipeline may be instructed to take some form of corrective action.

In one implementation, samples of a multimedia presentation include a data payload and timing information. In the course of processing the samples for presentation to the user, the samples pass through a pipeline that includes a number of components, each of which may process the samples in some manner. To determine whether the samples of the presentation are “on schedule,” the timing information is obtained from the samples at one or more of the components. The timing information is compared to a presentation clock that defines the timing of the presentation. If it is determined that one or more of the samples are not being processed by the component or components at the correct time, relative to the presentation clock, one or more of the components in the pipeline are instructed to take corrective action. For example, and without limitation, one of the components may be asked to drop one or more subsequently received samples.

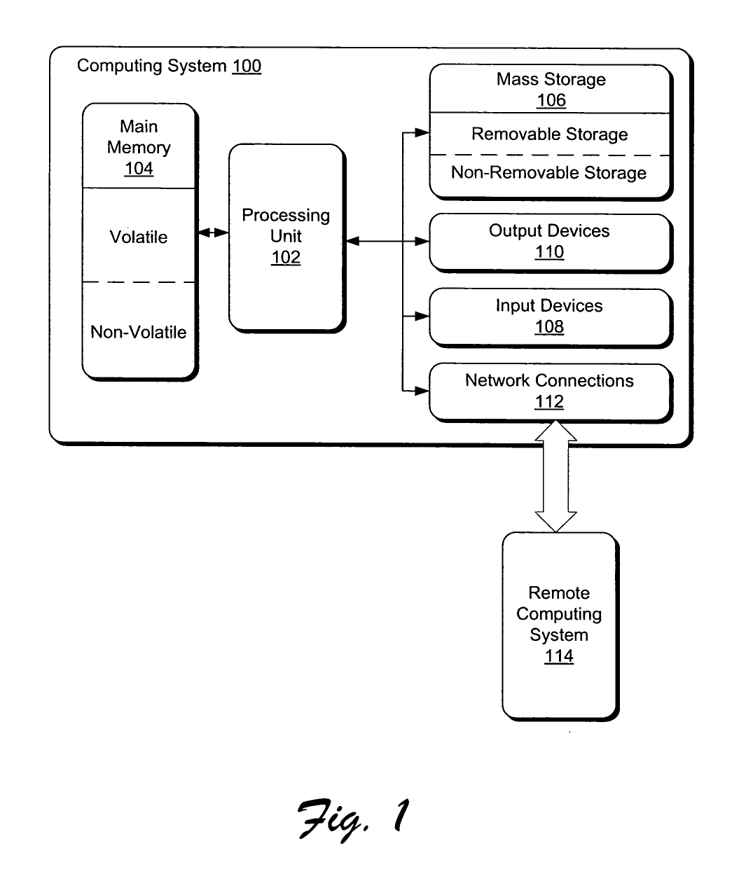

FIG. 1 illustrates one example of a computing system 100 in which a presentation quality management system may be implemented. In its most basic configuration, the computing system 100 includes a processing unit 102 and main memory 104, including volatile and/or non-volatile memory. Additionally, the computing system 100 may include or have access to various mass storage devices or systems 106, including various removable and/or non-removable mass storage devices. Examples of mass storage devices might be, without limitation, various magnetic, optical, and/or non-volatile semiconductor memory, etc. In the case where the mass storage device comprises a number of storage devices, those devices may be distributed, such as across a computer network.

The computing system 100 may have input devices 108, such as a keyboard, a pointing device (mouse), various optical scanners or readers, microphones, video cameras, or various other computer input devices. The computing system 100 may also have output devices 110, such as display devices, speakers, printers, or various other computer output devices. Other aspects of the computing system 100 may include network or communications connections 112 to other devices, computers, networks, servers, etc., using either wired or wireless computer-readable media. For example, the computing system 100 is shown in FIG. 1 as being connected to a remote computing system 114.

It should be appreciated that the remote computing system 114 may encompass various types computing systems or computing processes. For example, in one implementation, the remote computing system 114 is similar in basic structure and features to the computing system 100. Furthermore, the computing system 100 and the remote computing system 114 may be a part of, or in communication with, computer networks, such as Wide Area Networks (WAN), Local Area Network (LANs), the Internet, or any of various other computer networks.

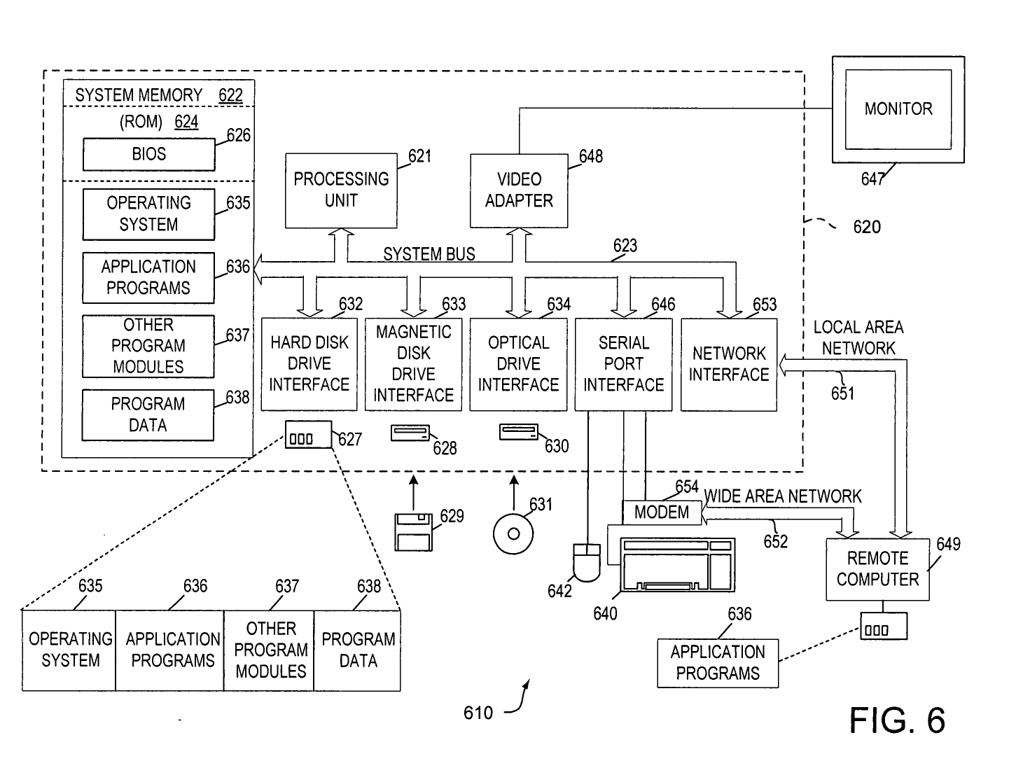

The computing system 100 illustrated in FIG. 1 is configured as a personal computer (PC). However, the computing system 100 may also assume a variety of other configurations, such as, without limitation, a mobile station, an entertainment appliance, a set-top box communicatively coupled to a display device, a wireless phone, a video game console, a personal digital assistant (PDA), and so forth. Thus, the computing system 100 may range from a full resource device with substantial memory and processor resources (e.g., PCs, television recorders equipped with hard disk, etc.) to a low-resource device with limited memory and/or processing resources (e.g., a traditional set-top box). A more comprehensively described example of a computing system 600 in which the system and methods described herein may be implemented is shown in FIG. 6.

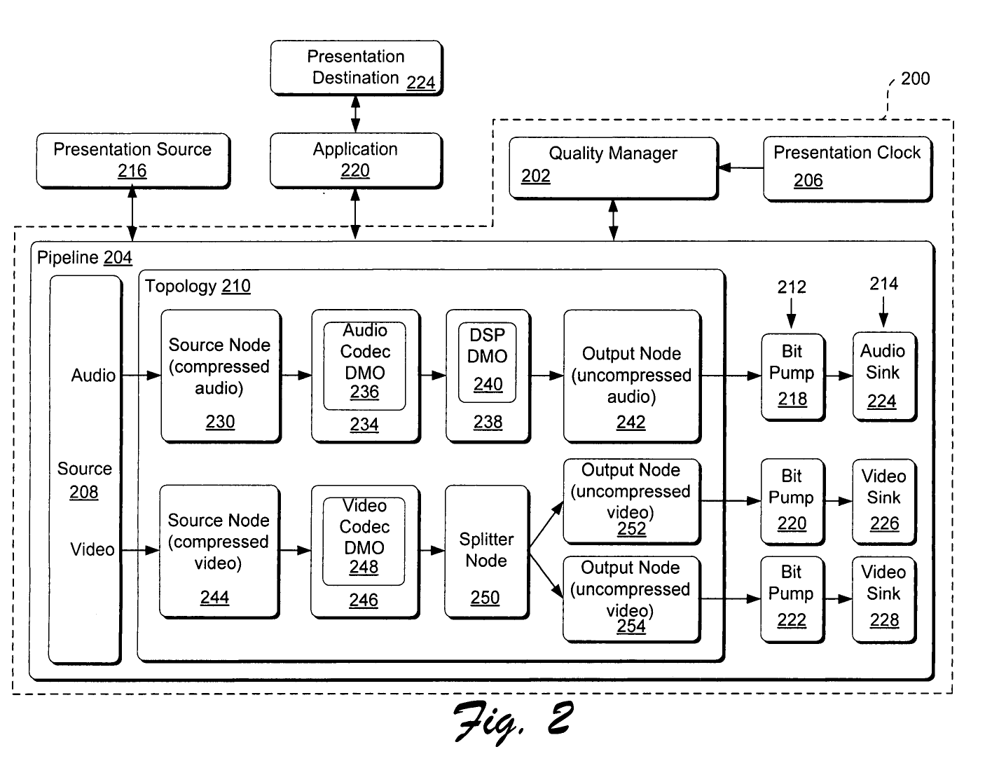

FIG. 2 illustrates an exemplary embodiment of a presentation quality management system (QMS) 200. In this implementation, the QMS 200 includes a quality manager 202, a component pipeline 204, and a presentation clock 206, each of which is described in detail below. Included in the pipeline 204 are one or more sources 208, a topology of nodes 210, a number of bit pumps 212, and a number of audio sinks 214. The sources 208, the nodes of the topology 210, the bit pumps 212, and the sinks 214 may each be referred to herein generally as components of the pipeline 202. In general, each component of the pipeline provides some sort of processing or handling of the data samples of a presentation. As shown in FIG. 2, a presentation source 216, including or providing one or more presentations, is operably connected to the pipeline 204. As also shown in FIG. 2, a presentation destination 224 is also operably connected to, and receives samples from, the pipeline 204. In accordance with various implementations, the application 220 creates the destination object 224. In accordance with various implementations, the application 220 also provides some form of control of the flow of samples from the pipeline 204 to the destination object 224.

In various implementations, the components of the pipeline 204, the quality manager 202, and the application 220 are composed of computer executable instructions that are stored or embodied in one or more types of computer-readable medium. As used herein, a computer-readable medium may be any available medium that can store and/or embody computer-executable instructions and that may be accessed by a computing system or computing process, such as, without limitation, the computing systems shown in FIGS. 1 and 7.

A computer-readable medium may include, without limitation, both volatile and nonvolatile memory, mass storage devices, removable and non-removable media, and modulated data signals. The term “modulated data signal” refers to a signal that has one or more of its characteristics set or changed in such a manner as to encode information in the signal.

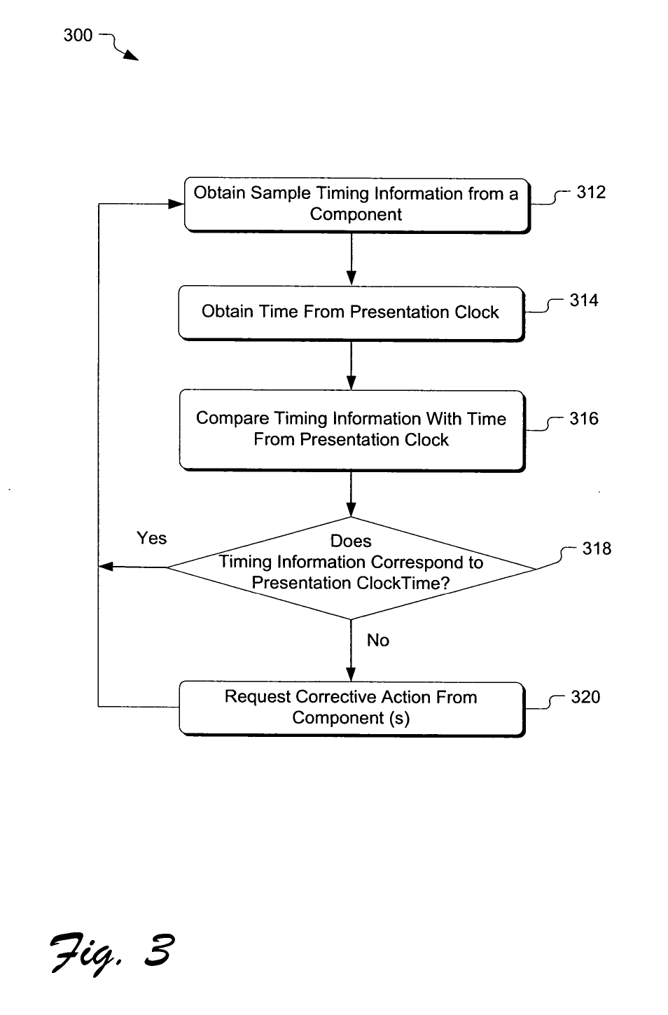

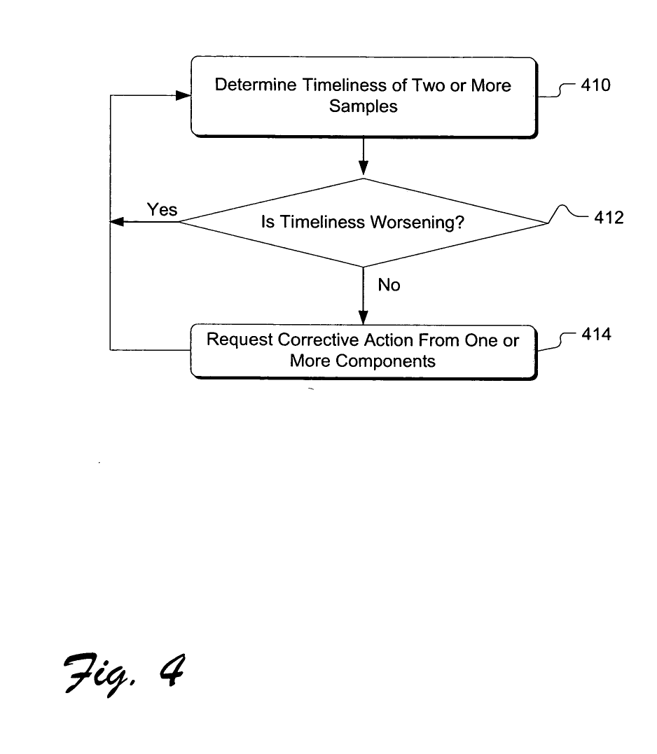

Generally, the components of the pipeline 202, the quality manager 204, and the application 220 may be composed of or include computer-executable instructions, various routines, programs, objects, components, data structures, etc., that perform particular tasks or operations and/or implement particular abstract data types. For example, in various implementations the quality manager 202 performs the operations illustrated in FIGS. 3, 4, and/or 5.

Any or all of the components of the pipeline 204, the quality manager 202, the application 220, the presentation destination 224, and the presentation clock 206 may be executed or implemented in a single computing device. Alternatively, any or all of the components of the pipeline 202, the quality manager 204, the application 220, the presentation destination 224, and the presentation clock 206 may be executed or implemented in a distributed computing environment, where various operations are performed by remote processing devices or systems that are linked through a communications network. For example, in accordance with one embodiment, the QMS 200 is executed or implemented in the computing system 100, while the application 220 is executed or implemented in the remote computing system 114.

It should be understood that while the pipeline 204, the quality manager 202, and the application 220 are described herein as comprising computer executable instructions embodied in computer-readable media, the pipeline 204, the quality manager 202, and the application 220, and any or all of the functions or operations performed thereby, may likewise be embodied all or in part as interconnected machine logic circuits or circuit modules within a computing device. Stated another way, it is contemplated that the pipeline 202, the quality manager 204, the application 220 and their operations and functions, such as the operations shown and described with respect to 3, 4, and/or 5, may be implemented as hardware, software, firmware, or various combinations of hardware, software, and firmware. The implementation is a matter of choice.

As previously noted, the systems and methods described herein act on, or are carried out with respect to, a multimedia presentation. In general, a multimedia presentation (“presentation”) is composed of one or more associated sample streams, wherein each sample stream includes a sequential grouping of data samples. Typically, a presentation includes one or more video, audio and/or text streams that together define an audiovisual program that, with appropriate audio and/or visual software (presentation application) and output devices, may be presented to a user.

As will be appreciated by those skilled in the art, the precise structure or format of a sample may vary. However, all or most of the samples of a presentation will typically include a data payload and some form of timing information. The data payload may include or comprise a pointer to data. This timing information is then used, in conjunction with the presentation clock, to allow for proper temporal ordering and/or manipulation of the samples of the presentation. In accordance with some implementations, the timing information comprises a time stamp that is relative to the beginning of the presentation.

As noted, the samples of a presentation are received or retrieved by the pipeline 204 from a presentation source 216. The presentation source 216 may be any type of system that is operable to deliver a presentation to the quality management system 200 and/or any type of computer-readable medium that is operable to store or embody the presentation. For example, and without limitation, the presentation source 216 may comprise a source for MP3 data, a source for DVD data, a source for WMA data, a timeline source, etc.

As described previously, the pipeline 204 includes a number of components that may be used to process or handle the samples of a presentation. The pipeline 204 may include any number and type of components. However, the pipeline shown in FIG. 2 illustrates only a few exemplary components.

Included in the pipeline illustrated in FIG. 2 are one or more source components 208 and one or more sink components 214. In general, a source component includes appropriate logic and resources to read a particular type of presentation data. For example, and without limitation, one type of source component may include appropriate logic and resources to capture video from a camera. Another type of source component may include appropriate logic and resources to capture audio from a microphone. Yet another type of source component may include appropriate logic and resources to read a compressed data stream. This source component may also have the appropriate logic and resources to separate the data stream into compressed video and compressed audio components. Yet another type of source might include appropriate logic and resources to get such data from the network. For illustration purposes, the source component 208 is shown as separating a compressed data stream into compressed video and compressed audio components.

Once the samples of a presentation are received by the source component 208, they are passed to and processed by the various nodes of the topology 210. In general, a topology, such as topology 210, includes a number of nodes, each of which provides some sort of digital signal processing with respect to the samples of a presentation. As will be appreciated by those skilled in the art, there are countless types of digital signal processing that may be carried out with respect to samples. As such, many different types of nodes may be available or developed for inclusion in a topology. For example, and without limitation, individual nodes may perform the functions of encoding, decoding, hue adjusting, contrast adjusting, equalization, frame rate adjusting, transition effects (wipes, fades, crossovers), surround sound spatialization (make stereo signals sound 3d), and so on.

In addition to sample processing functionality, a node may also include functionality for communicating with the quality manager 202. For example, and without limitation, nodes may have functionality for relaying timing information associated with the processing of samples to the quality manager 202. In this regard, in accordance with one implementation, various nodes read timing information from the samples and pass that timing information to the quality manager 202.

Nodes may determine and send node timing information to the quality manager 202 for a number of reasons. For example, a node may determine and send the node timing information to the quality manager 202 as a result of a request from the quality manager 202. Alternatively or additionally, a node may determine and send node timing information to the quality manager 202 as a result of a request from other processes. Alternatively or additionally, a node may determine and send node timing information to the quality manager 202 automatically as a result of a sample being received at a node. Nodes may send timing information to the quality manager before the sample is processed by the node and/or after the sample is processed by the node.

Nodes may also include functionality to perform various other actions with respect to samples that are specified by the quality manager 202. For example, and without limitation, a node may receive instructions from the quality manager 202 to drop one or more samples of a presentation. Nodes may also include functionality to perform various other actions in response to instructions from the quality manager. The precise instructions received from the quality manager, and the actions that are taken by the node as a result of receiving those instructions may vary, depending on the particular functionality of the node and the quality management processes being carried out by the quality manager 202. For example, and without limitation, a node may be instructed to reduce the quality of video filtering, reduce the quality of audio decoding, or drop one or more video frames, and so on.

As shown in FIG. 2, nodes process samples in particular order. That is, as a sample traverses the pipeline 204 (from left to right in FIG. 2), each node will receive, process, and send the sample in a particular order relative to the other nodes in the pipeline 210. Stated another way, the nodes are arranged relative to one another, such that a sample proceeds from one node to another in a particular order. This order of the nodes in the pipeline 204 is called the topology of the nodes. In the particular implementation illustrated in FIG. 2, the order of sample flow through the topology, as well as the general order of sample flow throughout the QMS 200, is indicated by lines and arrows.

The topology of the nodes may be set and implemented in various manners. For example, the topology may be predetermined by a user or process external to the QMS 200. In another example, the topology may be dynamically determined by a process outside of the QMS 200. Whether the topology is predetermined or set dynamically, as a sample traverses the pipeline 204 the sample will be delivered to each node in accordance with the topology.

In various implementations, the topology includes one or more signal pathways between a source and a sink. In accordance with these implementations, each signal pathway includes nodes for processing samples of a particular type. For example, as shown in FIG. 2, an audio pathway includes an audio source node 230, two audio wrapper nodes 234 and 238, and an audio output node 242. Likewise, a video pathway illustrated in FIG. 2 includes a video source node 244, a video wrapper node 246, a video splitter node 250, and two video output nodes 252 and 254.

In general, source nodes, whether audio, video, or some other type of source node, act as buffers or queues for samples, so that the flow of samples between the source and the nodes following the source nodes in the topology may be regulated. Similarly, output nodes, whether audio, video, or some other type of output node, act as buffers or queues for samples, so that the flow of samples between the nodes preceding the output nodes and the sinks may be regulated.

Wrapper nodes, such as 234 and 238, typically include, and provide appropriate interfaces for, signal processing objects which may be contained therein. This is particularly useful for accommodating processing applications or objects that are not specifically designed or configured for direct use as nodes in the QMS 200. For example, a wrapper node may include an object, such as a Microsoft® DirectX® Media Object (DMO). The wrapper node then handles all the details for interfacing the functions of the object, such as passing data to and from the object. Also, the wrapper node may include other functionality or interfaces that allow other processes or applications, such as application 220, and/or the quality manager 204 to communicate with and/or control the object.

In the particular implementation shown in FIG. 2, wrapper node 234 includes an audio coder/decoder (“codec”) DMO 236, wrapper node 238 includes a digital signal processing (DSP) DMO 240, and wrapper node 246 includes a video codec DMO. It should be understood that while the topology 210 illustrated in FIG. 2 includes only three wrapper nodes, the topology 210 may include various numbers of wrapper nodes, each of which may include various types of objects.

In accordance with various implementations, each output node passes samples to a corresponding bit pump 212. For example, as shown in FIG. 2, audio output node 242 passes samples to bit pump 212, video output node 252 passes samples to bit pump 220, and video output node 254 passes samples to bit pump 222. The bit pumps 212 then pass their corresponding data to the sinks 214.

In the implementations where bit pumps are employed, samples are passed from the bit pumps to sink components. For example, as shown in FIG. 2, bit pump 218 passes samples to audio sink 224, bit pump 220 passes samples to video sink 226, and bit pump 222 passes samples to video sink 228.

In general, the quality manager 202 monitors the timing of the samples as the samples flow through the pipeline 204. As previously noted, various ones of the components of the pipeline 204 send sample timing information to the quality manager, either before or after the samples are processed by the components.

As previously noted, presentations are composed of a number of samples. These samples typically include a data payload and timing information. As a given sample is processed by the components of the pipeline 204, one or more of the components reads the timing information from the sample and sends this timing information to the quality manager 202. The timing manager than takes some action to determine whether the timing of the sample is “on schedule,” relative to a presentation clock that is associated with the presentation.

In general, the presentation clock is a function that returns a monotonically increasing stream of timing values. Typically, the timing values increase in fixed timing increments, (e.g. 100-nanosecond increments). The presentation clock will typically not bear any permanent relation to any real time. Rather, the timing values will represent time increments that have passed from a predetermined start time, such as a defined beginning of a presentation.

In accordance with various implementations, the quality manager 202 compares the timing information from the samples to a presentation clock that. If it is determined that one or more of the samples are not being processed by the component or components at the correct time, relative to the presentation clock 206, one or more of the components in the pipeline are instructed to take corrective action. For example, and without limitation, one of the components may be asked to drop a subsequently received sample.

In accordance with other implementations, the quality manager 202 compares the timing information from a number of samples to the presentation clock 206. The timing information may be taken from a single component, or from a number of different components. If two more consecutive samples are determined to be late, the timing manager then determines if sample timing is deteriorating. That is, if the second received of the two or more samples is later, relative to its expected timing, than the first of the received samples. If it is determined that sample timing is deteriorating, one or more of the components in the pipeline are then instructed to take corrective action. For example, and without limitation, one of the components may be asked to drop a subsequently received sample.

In accordance with yet other implementations, a component in the pipeline includes appropriate logic to compare timing information in a sample to the presentation clock. In these implementations, the component then sends an indication to the quality manager that a sample was late. The component may send additional information to the quality manager such as the degree to which the sample was late. In accordance with a particular implementation, the component or components that make this timing determination is/are sink components.

In accordance with one implementation, the component that is instructed to take corrective action is the same component or components from which the timing information was received. In another implementation, the component that is instructed to take corrective action is different from the component or components from which the timing information was received. For example, in one implementation, timing information, or information indicating that a sample is late, is received from a sink and a node in the topology is instructed to take instructive action. In one particular implementation, a node containing a codec is instructed to drop one or more subsequently received sample. The number of samples that the quality manager instructs the node to drop may be dependent on the lateness of the sample or samples.

Turning now to FIG. 3, illustrated therein is an operational flow 300 that illustrates various operations for managing the timing of samples in a single sample stream of a presentation. In accordance with one implementation, one or more of the operations of the operational flow 300 are carried out by a quality manager, such as the quality manager 202 illustrated in FIG. 2, with respect to a multi-component pipeline. In other implementations, the operations of the operational flow 300 may be carried out in or by other systems and/or processes.

The operational flow may be carried out with respect any number of samples in a presentation. For example, the operational flow 300 could be carried out with respect to each sample in a presentation, or any subset of samples of a presentation. The operational flow 300 may be carried out at regular intervals, such as with respect every nth sample, or intermittently, such at the occurrence of a defined event or operational state.

At the beginning of the operational flow 300, a sample timing information operation 312 obtains from a component in the pipeline sample timing information. In one implementation, the timing information is obtained by requesting the information from the component. In another implementation, the component sends the timing information without having received a request. In one implementation, the timing information is obtained from the sample before the component processes the sample. In another implementation, the timing information is obtained from the sample after the component processes the sample.

In various implementations, the component from which the timing information is obtained reads the timing information from the sample. The timing information may have various forms. For example, and without limitation, the timing information may be time values, such as nanoseconds or the like, frame numbers, or SMPTE time codes.

The sample timing information may be obtained from various components in the pipeline. In one implementation, the timing information is received from a sink component. In another implementation, the timing information is obtained from a node in a topology, In one implementation, the timing information is obtained from a node that comprises or includes a codec.

A clock timing operation 314 obtains a time from a presentation clock associated with the presentation. A timing compare operation 316 then compares the sample timing information obtained from the component to the time from the presentation clock. A determination operation 318 determines if the sample timing information obtained from the component corresponds with the time from the presentation clock. In one embodiment, the determination operation 318 determines if the sample timing information is within a predetermined time of the time indicated by the presentation clock. In other embodiments, the determination operation 318 determines correspondence between the sample timing information and the time indicated by the presentation clock in other ways.

If it is determined by the determination operation 318 that the sample timing information obtained from the component corresponds with the time from the presentation clock, the operational flow returns to the sample timing information operation 312. If, however, it is determined by the determination operation 318 that the sample timing information obtained from the component does not corresponds with the time from the presentation clock, the operational flow proceeds to a correction operation 320.

The correction operation 320 requests one or more components in the pipeline to take some form of corrective action with respect to samples in the presentation. The correction operation 320 may request a variety of different corrective actions. For example, and without limitation, the correction operation 320 may request that one or more components drop one or more subsequently received samples of the presentation.

The correction operation 320 may request various components in the pipeline to take some form of corrective action. For example, in one implementation the correction operation 320 requests that the component and/or components from which the sample timing information was obtained to take the corrective action. In one implementation, the correction operation 320 requests that that a component comprising or including a codec take the corrective action. In yet another implementation, the correction operation 320 requests that that a sink component to take the corrective action. Following the correction operation 320, the operational flow returns to the sample timing information operation 312.

Turning now to FIG. 4, shown therein is an operational flow 400 that illustrates various operations for managing the timing of samples in a single sample stream of a presentation. In accordance with one implementation, one or more of the operations of the operational flow 400 are carried out by a quality manager, such as the quality manager 202 illustrated in FIG. 2, with respect to a multi-component pipeline. In other implementations, the operations of the operational flow 400 may be carried out in or by other systems and/or processes.

The operational flow 400 is carried out with respect to two or more samples in a presentation. For example, in one implementation, the operational flow 400 is carried out with respect to a pair of samples. In this implementation, the samples in a pair may be consecutive samples (i.e., the two samples are processed consecutively by a component). Alternatively, the samples in a pair may be non-consecutive.

Similarly, the operational flow 400 may be carried out with respect to consecutive sample pairs, non-consecutive sample pairs, or overlapping sample pairs. As used here, overlapping pairs of samples are sample pairs where the second sample in a first of the pairs is that same as the second sample in a second of the pairs. Likewise, when the operational flow is carried out with respect to a group of more than two samples, the operational flow 400 may be carried out with respect to more than two consecutive samples, more than two non-consecutive samples, or overlapping groups of more than two samples.

The operational flow 400 may be carried out at regular intervals, such as with respect every nth sample pair of samples or every nth group of more than two samples. Alternatively, the operational flow 400 may be carried out intermittently, such at the occurrence of a defined event or operational state.

At the beginning of the operational flow 400, a timeliness operation 410 determines the timeliness of two or more samples of a presentation at one or more components in a pipeline. That is, the timeliness operation 410 determines whether, for each of the two or more samples, if the sample was processed at its expected time at a component. If the sample was not processed at its expected time, the sample is said to be late. The amount of time a sample is late indicates the magnitude of the lateness of the sample. In one implementation, this timeliness determination is determined by obtaining sample timing information from a sample and comparing the timing information to a presentation clock.

In one implementation the timeliness operation 410 is carried out with respect to a single component. That is, timeliness for each of the two or more samples is determined relative to a common component. In another embodiment, the timeliness operation 410 is carried out with respect to two or more components. For example, the timeliness of one sample may be determined at one component, while the timeliness of another component is determined with respect to a different component.

In some implementations, components send the sample timing information as a result of receiving a request for the sample timing information. In another implementation, components send the sample timing information without having received a request. In one implementation, the timing information is obtained from the samples before the component processes the sample. In another implementation, the timing information is obtained from the samples after the component processes the sample.

Next, a determination operation 412 determines, based on the obtained sample timing information, if timeliness is worsening. This determination may be made in a number of ways. In one implementation, this determination is made by first determining if at least two of the two or more samples are late at a component. If at least two of the two or more samples are late at a component, it is determined whether the magnitudes of the lateness of the two of the two or more samples indicate that samples are getting later as the presentation progresses. For example, in the case where a pair of samples is being examined, if the magnitude of the lateness of a second of the pair of samples, relative to the time frame of the presentation, is greater than the magnitude of the first of the pair of samples, it may be said that the timeliness of the samples is worsening.

If it is determined at determination operation 412 that timeliness is not worsening, the operational flow 400 returns to the timeliness operation 410. If, however, it is determined at determination operation 412 that timeliness is worsening, the operational flow 400 proceeds to a correction operation 414.

The correction operation 414 requests one or more components in the pipeline to take some form of corrective action with respect to samples in the presentation. The correction operation 414 may request a variety of different corrective actions. For example, and without limitation, the correction operation 414 may request that one or more components drop one or more subsequently received samples of the presentation.

The correction operation 414 may request various components in the pipeline to take some form of corrective action. For example, in one implementation the correction operation 414 requests that the component and/or components from which the sample timing information was obtained to take the corrective action. In one implementation, the correction operation 414 requests that that a component comprising or including a codec take the corrective action. In yet another implementation, the correction operation 414 requests that that a sink component to take the corrective action. Following the correction operation 414, the operational flow returns to the timeliness operation 410.

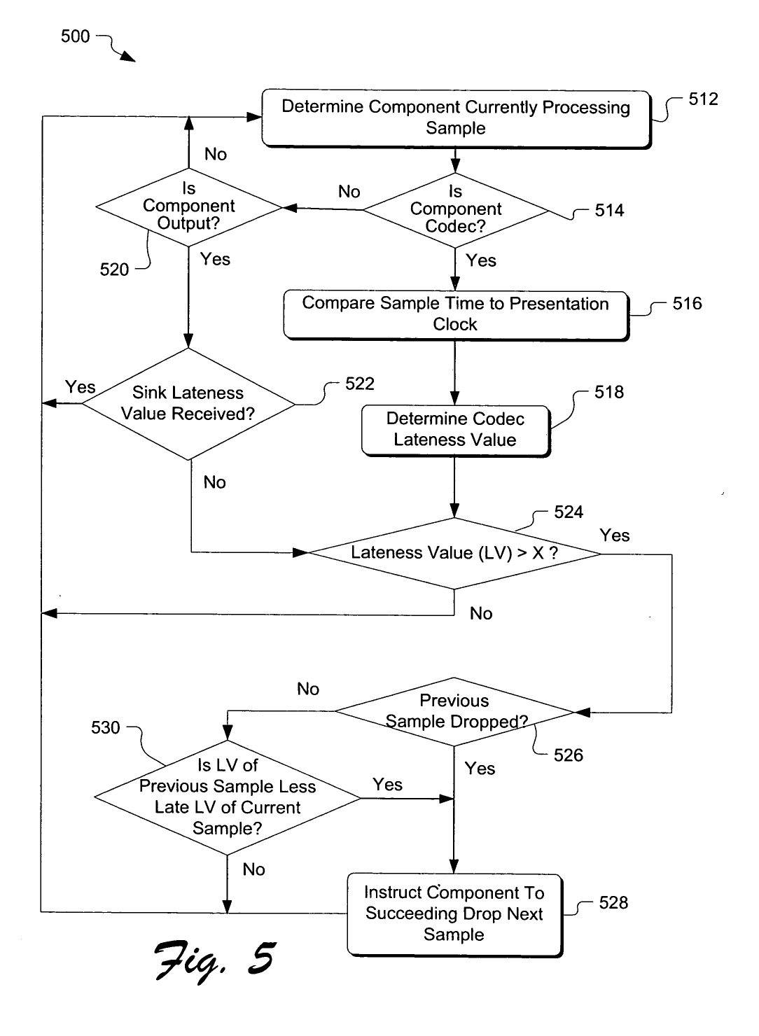

Turning now to FIG. 5, shown therein is an operational flow 500 that illustrates various operations for managing the timing of samples in a single sample stream of a presentation. More particularly, the operational flow 500 illustrates various operations for managing the timing of samples of a presentation in a multi-component pipeline including at least a sink component and a topology of nodes, wherein the topology of nodes includes at least one node that provides codec functionality and one output node.

In accordance with one implementation, one or more of the operations of the operational flow 500 are carried out in or by a quality manager, such as the quality manager 202 illustrated in FIG. 2. In other implementations, the operations of the operational flow 500 may be carried out in or by other systems and/or processes. However, with respect to the description of the operational flow 500 below, it will be assumed that a quality manager is carrying out the operational flow 500. Furthermore, it is assumed that samples include timing information. Also, it is assumed that the quality manager has access to a presentation clock associated with the presentation.

Generally, the operational flow 500 will be executed in a continuous loop by the quality manager while the samples of a presentation stream are being processed in a pipeline. The operations of the operational flow 500 are generally carried out with respect to each sample (“the current sample”) that is processed in the pipeline.

At the beginning of the operational flow 500, a determine component operation 512 determines which component in the pipeline is processing the current sample. The manner in which the determine component operation 512 makes this determination may vary. For example, and without limitation, the component processing the current sample may send this information to the quality manager as a result of its processing of the current sample. In another implementation, the component processing the current sample sends this information to the quality manager as a result of a request from the quality manager or some other process external to the quality manager.

Next, a codec determination operation 514 determines whether the component processing the current sample includes or comprises a codec (“codec component”). If it is determined that the component processing the current sample was the codec component, a compare sample time operation 516 then compares the timing information from the current sample with the presentation clock. A codec lateness determination operation 518 then specifies a codec lateness value that indicates, if any, the amount of time the current sample was late to the codec component.

In accordance with one implementation, the codec lateness value will be the precise time between the time indicated in the timing information in the current sample and the time of the presentation clock. In other implementations, some sort time tolerance will be allowed. In such a case, the codec lateness value will the time between the time indicated by the timing information in the current sample and the time of the presentation clock, minus some tolerance value.

Returning to the codec determination operation 514, if it is determined therein that the component processing the current sample is not the codec component, output determination operation 520 determines whether the component processing the current sample is an output node component. If it is determined that the component processing the current sample is not an output node component, the operational flow 500 returns to the determine component operation 512. However, if it is determined that the component processing the current sample is an output node component, the operational flow 500 proceeds to a sink lateness value received operation 522.

The sink lateness value received operation 522 determines if a sink lateness value has been received from the sink component, thus indicating that the current sample was late to the sink. The sink lateness value is calculated by the sink component. The sink lateness value may be calculated in the same manner as the codec lateness value in codec lateness determination operation 518, described above.

If it is determined that a sink lateness value has not been received from the sink component, the operational flow 500 returns to the determine component operation 512. However, if it is determined that a sink lateness value has been received from the sink component, thus indicating that the current sample was late to the sink, the operational flow 500 proceeds to a lateness threshold operation 524.

The lateness threshold operation 524 determines if the last lateness value received, from either the codec lateness determination operation 518 or the sink lateness value received operation 522, is greater than some value X. If it is determined that the last lateness value received is not greater than X, the operational flow 500 returns to the determine component operation 512. However, it is determined that last lateness value received is not greater than X, the operational flow 500 proceeds to a dropped sample determination operation 524.

The dropped sample determination operation 524 determines whether the quality manager instructed a component to drop a sample previously processed by the quality manager (“previous sample”). In one implementation, the previously processed sample will be the sample immediately preceding the current sample in the presentation. In other implementations, the previously processed sample may be a sample other than the sample immediately preceding the current sample in the presentation.

If it is determined that the quality manager instructed a component to drop the previously processed sample, a drop sample operation 528 instructs a component in the pipeline to drop a succeeding sample. In one implementation, the succeeding sample is the sample immediately succeeding the current sample in the presentation. In other embodiments, the succeeding sample may be a sample other than the sample immediately succeeding the current sample in the presentation. In yet other implementations, the succeeding sample may comprise more than one sample, such as each sample of a frame of video data.

If it is determined that the quality manager did not instruct a component to drop the previously processed sample, the operational flow 500 proceeds to a lateness value (LV) comparison operation 530. The lateness value comparison operation 530 compares the LV of the previous sample with the LV of the current sample. If it is determined from this comparison that the LV of the previous sample is greater than the LV of the current sample, thus indicating that samples timeliness in the presentation is improving, the operational flow 500 returns to the determine component operation 512. However, if it is determined from this comparison that the LV of the previous sample is not greater than the LV of the current sample, thus indicating that samples timeliness in the presentation is worsening, the operational flow 500 proceeds to drop sample operation 528, described above.

FIG. 6 illustrates one operating environment 610 in which the various systems, methods, and data structures described herein may be implemented. The exemplary operating environment 610 of FIG. 6 includes a general purpose computing device in the form of a computer 620, including a processing unit 621, a system memory 622, and a system bus 623 that operatively couples various system components include the system memory to the processing unit 621. There may be only one or there may be more than one processing unit 621, such that the processor of computer 620 comprises a single central-processing unit (CPU), or a plurality of processing units, commonly referred to as a parallel processing environment. The computer 620 may be a conventional computer, a distributed computer, or any other type of computer.

The system bus 623 may be any of several types of bus structures including a memory bus or memory controller, a peripheral bus, and a local bus using any of a variety of bus architectures. The system memory may also be referred to as simply the memory, and includes read only memory (ROM) 624 and random access memory (RAM) 625. A basic input/output system (BIOS) 626, containing the basic routines that help to transfer information between elements within the computer 620, such as during start-up, is stored in ROM 624. The computer 620 further includes a hard disk drive 627 for reading from and writing to a hard disk, not shown, a magnetic disk drive 628 for reading from or writing to a removable magnetic disk 629, and an optical disk drive 630 for reading from or writing to a removable optical disk 631 such as a CD ROM or other optical media.

The hard disk drive 627, magnetic disk drive 628, and optical disk drive 630 are connected to the system bus 623 by a hard disk drive interface 632, a magnetic disk drive interface 633, and an optical disk drive interface 634, respectively. The drives and their associated computer-readable media provide nonvolatile storage of computer-readable instructions, data structures, program modules and other data for the computer 620. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 629, optical disk 631, ROM 624, or RAM 625, including an operating system 635, one or more application programs 636, other program modules 637, and program data 638. A user may enter commands and information into the personal computer 620 through input devices such as a keyboard 40 and pointing device 642. Other input devices (not shown) may include a microphone, joystick, game pad, satellite dish, scanner, or the like. These and other input devices are often connected to the processing unit 621 through a serial port interface 646 that is coupled to the system bus, but may be connected by other interfaces, such as a parallel port, game port, or a universal serial bus (USB). A monitor 647 or other type of display device is also connected to the system bus 623 via an interface, such as a video adapter 648. In addition to the monitor, computers typically include other peripheral output devices (not shown), such as speakers and printers.

The computer 620 may operate in a networked environment using logical connections to one or more remote computers, such as remote computer 649. These logical connections may be achieved by a communication device coupled to or a part of the computer 620, or in other manners. The remote computer 649 may be another computer, a server, a router, a network PC, a client, a peer device or other common network node, and typically includes many or all of the elements described above relative to the computer 620, although only a memory storage device 650 has been illustrated in FIG. 6. The logical connections depicted in FIG. 6 include a local-area network (LAN) 651 and a wide-area network (WAN) 652. Such networking environments are commonplace in office networks, enterprise-wide computer networks, intranets and the Internal, which are all types of networks.

When used in a LAN-networking environment, the computer 620 is connected to the local network 651 through a network interface or adapter 653, which is one type of communications device. When used in a WAN-networking environment, the computer 620 typically includes a modem 654, a type of communications device, or any other type of communications device for establishing communications over the wide area network 652. The modem 654, which may be internal or external, is connected to the system bus 623 via the serial port interface 646. In a networked environment, program modules depicted relative to the personal computer 620, or portions thereof, may be stored in the remote memory storage device. It is appreciated that the network connections shown are exemplary and other means of and communications devices for establishing a communications link between the computers may be used.

Although some exemplary methods and systems have been illustrated in the accompanying drawings and described in the foregoing Detailed Description, it will be understood that the methods and systems shown and described are not limited to the particular implementation described herein, but rather are capable of numerous rearrangements, modifications and substitutions without departing from the spirit set forth and defined by the following claims.

1. A method comprising:
determining whether at least one sample of a presentation is processed by a first component of a pipeline at an expected time; and
requesting a second component of the pipeline to alter the manner in which the second component processes a portion of the presentation if the sample is not processed at the expected time.

2. A method as recited in claim 1, wherein the first component comprises a media sink.

3. A method as recited in claim 1, wherein the second component comprises a codec.

4. A method as recited in claim 1, wherein the first component comprises a media sink and the second component comprises a codec.

5. A method as recited in claim 1, wherein the portion of the presentation comprises a sample.

6. A method as recited in claim 1, wherein the portion of the presentation comprises a sample other than the at least one sample.

7. A method as recited in claim 1, wherein the portion of the presentation comprises a frame.

8. A method as recited in claim 1, wherein determining whether the at least one sample is processed at the expected time comprises comparing a timing value in the at least one sample to a predetermined time frame associated with the presentation.

9. A method as recited in claim 1, wherein determining whether the at least one sample is processed at the expected time comprises comparing a timing value in the at least one sample to a presentation clock.

10. A method as recited in claim 1, wherein determining whether the at least one sample is processed at the expected time comprises determining whether a timing value in the at least one sample was processed by the first component at the time specified by the timing value.

11. A method as recited in claim 1, wherein determining whether the at least one sample is processed at the expected time comprises determining whether a timing value in the at least one sample was processed by the first component within a given time of a time specified by the timing value.

12. A method as recited in claim 1, wherein the at least one sample comprises a first sample and a second sample and wherein determining whether the at least one sample is processed at the expected time comprises determining if the first sample is processed by the first component at a first expected time and determining if the second sample is processed by the first component at a second expected time.

13. A method as recited in claim 1, wherein the at least one sample comprises a first sample and a second sample and wherein determining whether the at least one sample is processed at the expected time comprises:
determining a first timing error as a difference between a time at which the first sample is processed by the first component and a time at which the first sample is expected to be processed;
determining a second timing error as a difference between a time at which the second sample is processed by the first component and a time at which the first sample is expected to be processed; and
determining if the second timing error is greater than the first timing error.

14. A method as recited in claim 1, wherein the at least one sample comprises a first sample including a first timing value and a second sample including a second timing value and wherein determining whether the at least one sample is processed at the expected time comprises determining whether the first timing value more closely corresponds to a time at which the first sample is processed by the first component than the second timing value corresponds to a time at which the second sample is processed by the first component.

15. A method as recited in claim 1, wherein altering the manner in which the second component processes a portion of the presentation comprises dropping at least one sample of the presentation.

16. A method as recited in claim 1, wherein altering the manner in which the second component processes a portion of the presentation comprises dropping at least one frame of the presentation.

17. A method as recited in claim 1, wherein the first component is a media sink, the second component is a codec, and the wherein altering the manner in which the second component processes a portion of the presentation comprises dropping at least one frame of the presentation.

18. A method as recited in claim 1, wherein:
the pipeline includes a media source, a media sink, and a topology of media processing nodes;
the first component is a node in the topology; and
the second component is the media sink.

19. A method as recited in claim 1, wherein:
the pipeline includes a media source, a media sink, and a topology of media processing nodes;
the first component is a node in the topology including a codec; and
the second component is the media sink.

20. A method comprising:
determining if timeliness of sample processing in a multi-component pipeline is degrading, the determination being made based on processing times of a first sample and a second sample of a presentation;
altering the manner in which a component in the pipeline processes a portion of the presentation if the timeliness of sample processing is degrading.

21. A method as defined in claim 20, wherein the processing times of the first and the second samples are determined relative to a single component in the pipeline.

22. A method as defined in claim 20, wherein the processing times of the first component is determined relative to a first component in the pipeline and the processing times of the second component is determined relative to a second component in the pipeline.

23. A method as defined in claim 20, wherein the processing times of the first and the second samples are determined using timing information in the samples.

24. A method as defined in claim 20, wherein the processing times of the first and the second samples are determined using timing information in the samples and a presentation clock.

25. A method as defined in claim 20, wherein timeliness of sample processing is determined based on:
a first timing difference between a time specified in a timing value in the first sample and a that time the first sample is processed by a component in the pipeline;
a second timing difference between a time specified by a timing value in the second sample and a time that the second sample is processed by a component in the pipeline.

26. A method as defined in claim 20, wherein timeliness of sample processing is determined based on:
a first timing difference between a time specified in a timing value in the first sample and a time that the first sample is processed by a first component in the pipeline;
a second timing difference between a time specified by a timing value in the second sample and a time that the second sample is processed by second component in the pipeline.

27. A method as defined in claim 20, wherein timeliness of sample processing is determined by:
determining a first timing difference between a time specified in a timing value in the first sample and a time that the first sample is processed by a component in the pipeline;
determining a second timing difference between a time specified by a timing value in the second sample and a time that the second sample is processed by a component in the pipeline, wherein the second sample is processed at a later time than the first sample; and
determining that timeliness of sample processing is degrading if the second timing difference is greater than the first timing difference.

28. A method as defined in claim 20, wherein timeliness of sample processing is determined by:
determining a first timing difference between a time specified in a timing value in the first sample and a time that the first sample is processed by a selected component in the pipeline;
determining a second timing difference between a time specified by a timing value in the second sample and a time the second sample is processed by the selected component, wherein the second sample is processed at a later time than the first sample; and
determining that timeliness of sample processing is degrading if the second timing difference is greater than the first timing difference.

29. A method as defined in claim 20, wherein altering the manner in which a component in the pipeline processes a portion of the presentation comprises instructing the component to drop a sample.

30. A method as defined in claim 20, wherein altering the manner in which a component in the pipeline processes a portion of the presentation comprises instructing the component to drop each sample in a frame of the presentation.

31. A method as defined in claim 20, wherein each component comprises processor executable instructions executed by a processor.

32. A computerized system, comprising:
a plurality of sample processing components operably connected to form a pipeline operable to process samples of a presentation; and
a quality manager that monitors sample processing times in the pipeline and, based on the monitored sample processing times, controls the manner in which at least one of the components processes a portion of the presentation.

33. A computerized system as recited in claim 32, wherein at lease one of the sample processing components comprises a media sink, and wherein the quality manager monitors sample processing times at the media sink.

34. A computerized system as recited in claim 32, wherein controlling the manner in which at least one of the components processes a portion of the presentation comprises instructing the component to drop a sample of the presentation.

35. A computerized system as recited in claim 32, wherein controlling the manner in which at least one of the components processes a portion of the presentation comprises instructing the component to drop all of the samples of a frame of the presentation.

36. A computerized system as recited in claim 32, wherein the quality manager controls the manner in which at least one of the components processes a portion of the presentation based on two or more samples of the presentation.

37. A computerized system as recited in claim 32, wherein the quality manager monitors sample processing times at a first component and, based on the monitored sample processing time at the first component, controls the manner in which a second component processes a portion of the presentation.

38. A computerized system as recited in claim 32, wherein the quality manager monitors sample processing times at a sink component and, based on the monitored sample processing time at the sink component, controls the manner in which a codec component processes a portion of the presentation.

39. A computerized system as recited in claim 32, wherein the quality manager monitors the processing times of two samples at a sink component and, based on the monitored sample processing times of the two samples at the sink component, requests that the codec component drop at lease one frame of the presentation.

40. A computerized system as recited in claim 32, further comprising a presentation clock associated with the presentation, wherein the quality manager monitors sample processing times in the pipeline relative to the presentation clock.

41. A computerized system as recited in claim 32, further comprising a presentation clock associated with the presentation, wherein a plurality of the samples of the presentation include timing information, and wherein the quality manager monitors sample processing times in the pipeline by comparing the timing information of the samples to the presentation clock.

42. A processor-readable medium having stored thereon processor executable instructions for performing acts comprising:
determining a timing value associated with a sample of a presentation being processed by a first component in a pipeline;
determining if the sample is on time by comparing the timing value to a presentation clock associated with the presentation; and
requesting a second component in the pipeline to drop a sample of the presentation if the sample is not on time.

43. A processor-readable medium as recited in claim 42, wherein the timing value is included in the sample.

44. A processor-readable medium as recited in claim 42, wherein the first component is a sink component.

45. A processor-readable medium as recited in claim 42, wherein the second component is a codec.

46. A processor-readable medium as recited in claim 42, wherein the first component is a sink component and the second component is a codec.

47. A processor-readable medium having stored thereon processor executable instructions for performing acts comprising:
determining timing information associated with at least two samples of a presentation processed by a first component in a pipeline;
determining if the sample timing is degrading by comparing the timing information associated with the at least two samples to a presentation clock associated with the presentation; and
instructing at least one component in the pipeline to alter than manner in which the at least one component processes a portion of the presentation if the sample time is degrading.

48. A processor-readable medium as recited in claim 47, wherein the timing information are included in the samples.

49. A processor-readable medium as recited in claim 42, wherein the first component is a sink component.

50. A processor-readable medium as recited in claim 42, wherein the at least one component is a codec.

51. A processor-readable medium as recited in claim 42, wherein the first component is a sink component and the at least one component is a codec.
